(19) United States
(12) Patent Application Publication
(10) Pub. No.: US 2012/0315399 A1
(43) Pub. Date: Dec. 13, 2012

(54) METHOD OF MAKING NANOPARTICLE REINFORCED METAL MATRIX COMPONENTS

(76) Inventors: Zhili FENG, Knoxville, TN (US); Jun QU, Oak Ridge, TN (US); Michael L. SANTELLA, Knoxville, TN (US); Tsung-Yu PAN, Ypsilanti, MI (US); Allen D. ROCHE, Saline, MI (US); Sheng-Tao YU, Ann Arbor, MI (US)

(21) Appl. No.: 13/463,549

(22) Filed: May 3, 2012

Related U.S. Application Data
(60) Provisional application No. 61/481,869, filed on May 3, 2011.

(51) Int. Cl. C22B 5/00; B22F 3/15; B05D 3/00; B05D 3/12; B22D 25/00; B22F 3/02; B05D 7/14

(52) U.S. Cl. 427/292; 419/66; 419/26; 427/401; 75/414; 164/97; 427/372.2

(57) ABSTRACT

A method of making a nanoparticle reinforced metal matrix component is provided. The method involves solid state processing nanoparticles into a metal matrix material at solid state processing conditions to form a master alloy. At least a portion of the master alloy is added to a mass of metal melt to produce the nanoparticle reinforced metal matrix component.

### CROSS REFERENCE TO RELATED APPLICATIONS

This application claims the benefit of and priority to U.S. Provisional Application No. 61/481,869, filed 3 May 2011, the entirety of which application is incorporated herein by reference.

### GOVERNMENT RIGHTS

This invention was made with government support under Contract No. DE-AC05-00OR22725 awarded by the U.S. Department of Energy. The government has certain rights in the invention.

### FIELD OF THE INVENTION

The present invention generally relates to the production of reinforced metal matrix materials. More particularly, the invention relates to the production of metal matrix materials reinforced with a distribution, preferably a homogeneous distribution, of nanoparticles.

### BACKGROUND OF THE INVENTION

While the addition of micron sized particles to a metal matrix can improve material properties or characteristics such as stiffness, wear properties and strength, for example, the addition of low concentrations, e.g., <2% by volume, of nanosized particles, i.e., nanoparticles, to a metal matrix can additionally improve material properties or characteristics such as high temperature creep resistance and ductility as well as to improve control of the coefficient of thermal expansion, as compared to metal matrix composites reinforced with micron-sized particulates. For example, a homogeneous distribution of nanoparticles in a magnesium alloy would be suitable for elevated temperature applications such as powertrain components, as a low cost alternative to expensive creep resistant rare-earth magnesium alloys.

One of the main challenges faced in achieving a homogeneous distribution of nanoparticles in a metal matrix is undesired agglomeration and clustering of the nanoparticles. This challenge becomes even more daunting when the size of the reinforcement particles is small and the volume fraction is high. With processes such as casting, fine particles (e.g., particles <1 micron), are typically difficult to wet and distribute uniformly in a molten metal, resulting in low levels of entrained particles, microporosity and poor fatigue and fracture toughness.

Powder metallurgy processes such as involving mechanical alloying can be used in attempts to make materials with high concentrations of nanoparticles. Mechanical alloying and powder metallurgy methods for producing nanoparticle-loaded metal matrix composites, however, tend to be slow and expensive and do not readily lend themselves to mass production.

Thus, there is a need and demand for a processing technology for the production of a metal matrix material with a distribution, preferably a homogeneous distribution, of nanoparticles. More particularly there is a need for a processing technology that exhibits at least one or more of the following characteristics or properties: improved scalability, lower cost and improved effectiveness at distributing nanoparticles in a matrix material, preferably with an even or more even distribution of the nanoparticles in the metal matrix, e.g., without agglomeration or clustering.

### SUMMARY OF THE INVENTION

The present invention provides improved methods for producing a nanoparticle reinforced metal matrix material.

In accordance with one aspect, the invention relates to the production of a metal matrix material with a distribution, preferably a homogeneous distribution, of nanoparticles.

In accordance with one such method, a nanoparticle reinforced metal matrix component is made by solid state processing nanoparticles into a metal matrix material at solid state processing conditions to form a master alloy. At least a portion of the master alloy is then added to a mass of metal melt, e.g., a molten metal or semi-solid material, to produce the nanoparticle reinforced metal matrix component.

In accordance with one specific method, a nanoparticle reinforced metal matrix component is made by forming a slurry containing the nanoparticles in a suitable liquid. A plurality of cavities in a metal matrix material are filled at least in part with the nanoparticle-containing slurry. The nanoparticles in the filled cavities are friction stir processed into the metal matrix material at friction stir processing conditions to form a master alloy. At least a portion of the master alloy is then added to a mass of metal melt, e.g., a molten metal or semi-solid material, to produce the nanoparticle reinforced metal matrix component.

As used herein, references to:
“CTE” are to be understood to refer to the coefficient of thermal expansion;
“FSE” are to be understood to refer to friction stir extrusion;
“FSP” are to be understood to refer to friction stir processing;
“HIP” are to be understood to refer to Hot Isostatic Pressing;
“master alloy” are to be understood to generally refer to a metal matrix materials or base metals combined with a relatively high percentage of one or two other elements, for example, as described in greater detail below, nanoparticles are added to a suitable metal matrix material such as via a master alloy that may contain up to 30 volume percent nanoparticles, for example;
“metal melt” or “metallic melt” are to be understood to refer to the mass of molten metal or semi-solid material to which the master alloy is added;
“MMC” are to be understood to refer to metal matrix composites;
“MMM” are to be understood to refer to metal matrix materials;
“nanoparticles” are to be understood to refer to particles having a size of less than 100 nm;
“NP” are to be understood to refer to nanosized particles, i.e., nanoparticles;
“PM” are to be understood to refer to powder metallurgy;
“UTS” are to be understood to refer to ultimate tensile strength.

Other objects and advantages will be apparent to those skilled in the art from the following detailed description taken in conjunction with the appended claims and drawings.

### BRIEF DESCRIPTION OF THE DRAWINGS

The above-mentioned as well as other features and objects of the invention will be better understood from the following detailed description taken in conjunction with the drawings wherein:

FIG. 1 is a schematic representation of friction stir processing as applied to a work piece.

FIGS. 2A-2D are schematic illustrations of typical sequential steps in friction stir processing applied to a work piece.

FIG. 3 is a schematic illustrating several possible arrangements of cavities for holding NP's in a matrix material.

FIG. 4 shows a cross-section through the thickness of an FSP plate in accordance with one embodiment of the invention.

FIG. 5 is a plan view X-ray image of a metal matrix material including friction stirred processed metal powder in accordance with one embodiment of the invention.

FIG. 6 is a low-magnification optical micrograph of cross-sectioned sample of a remelted AZ31+SiC ingot material.

FIG. 7 is a low-magnification scanning electron micrograph (SEM) of the same general area as shown in FIG. 6. However, these two figures have different orientations and mirrored images.

FIG. 8 is a medium-magnification back-scattering (BS) electron micrograph of the remelted AZ31+SiC ingot material, in the same general area as in FIG. 6 but with different orientations of images.

FIG. 9 is a scanning electron micrograph of a SiC nanoparticle cluster of the remelted AZ31+SiC ingot material, showing individual SiC nanoparticles.

FIG. 10 is a graphical comparison of yield strength of as-cast ingots of AZ31, AZ31+Al₂O₃ and AZ31+SiC.

FIG. 11 is a graphical comparison of ultimate tensile strength of as-cast ingots of AZ31, AZ31+Al₂O₃ and AZ31+SiC.

FIG. 12 is a graphical comparison from bolt load retention test results for as-cast ZA31, AZ31+SiC and AZ31 wrought plate.

FIGS. 13A-13D are schematic illustrations of typical sequential steps in producing a master alloy by friction stir extrusion.

FIG. 14 shows master alloy pellets made by FSE in accordance with one embodiment of the invention.

### DETAILED DESCRIPTION OF THE INVENTION

One aspect of the invention is concerned with the production of a master alloy containing large concentrations of nanoparticles intimately mixed into a metal matrix such as via solid state processing at solid state processing conditions. The master alloy, in whole or in part, can then be added to a mass of molten metal or semi-solid material to produce, such as by casting or semi-solid molding processes, high strength, creep resistant metal matrix nanocomposite components suitable for structural and other high performance applications.

Those skilled in the art and guided by the teaching herein provided will understand and appreciate that the broader practice of the invention is not necessarily limited to specific or particular materials for the nanoparticles, metal matrix, and metal melt. For example, in accordance with selected embodiments of the invention, suitable metal matrix materials may contain or include one or more materials such as Mg, Al, Sn, Zn, Fe, Ni, Ti and their alloys. Similarly, in accordance with selected embodiments of the invention, suitable metal melt materials may contain or include one or more materials such as Mg, Al, Sn, Zn, Fe, Ni, Ti and their alloys.

In accordance with certain embodiments of the invention, suitable nanoparticle materials for use in the practice of the invention generally include those materials which will not dissolve when the master alloy is added to the metal melt. Nanoparticle materials that can be processed in accordance with the invention generally include metal oxides, carbides, and metals and have a size in the range of 1 nm to 1000 nm. Nanoparticle materials in accordance with one embodiment are preferably ceramic and wetted by the melt material. If desired, the nanoparticles can be coated with material which promotes wetting when distributed in molten metals. For example, alumina NP's can be coated with Ni such as via conventional electroless nickel processing. The coated NP's can then be used in the desired solid state processing technique to make the master alloy, the coating serving to promote wetting of the alumina NP's when the master alloy is dispersed in a melt such as tin, for example. In accordance with one preferred embodiment, a preferred combination of metal matrix and NP is Mg (AZ91) and 50 nm SiC NP's.

Those skilled in the art and guided by the teachings herein provided will appreciate that various solid state processing techniques can be utilized in the practice of the invention, For example, suitable such processing techniques include friction stir processing (FSP), friction stir extrusion (FSE) and Hot Isostatic Pressing (HIP).

In accordance with one preferred embodiment, a master alloy is desirably made, formed or produced using friction stir processing (FSP) technology.

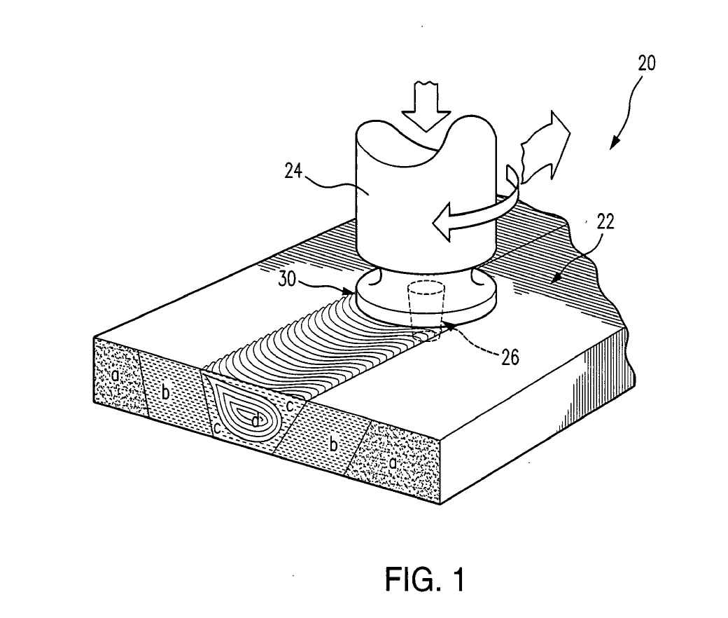

FIG. 1 schematically represents a friction stir process, generally designated by the reference numeral 20, as applied to a work piece 22. A rotating tool 24 such as having a tool extending profiled pin 26 and a tool shoulder 30 is placed into work contact with the work piece 22. As a result, the work piece 22 has:
a zone “a” of material that is generally unaffected by the action of the rotating tool 24;
a zone “b” of material that is heat affected; and
a zone “c” of material that is thermomechanically affected.

The thermomechanically affected zone of material “c” may contain or include a weld nugget “d”, as shown in FIG. 1.

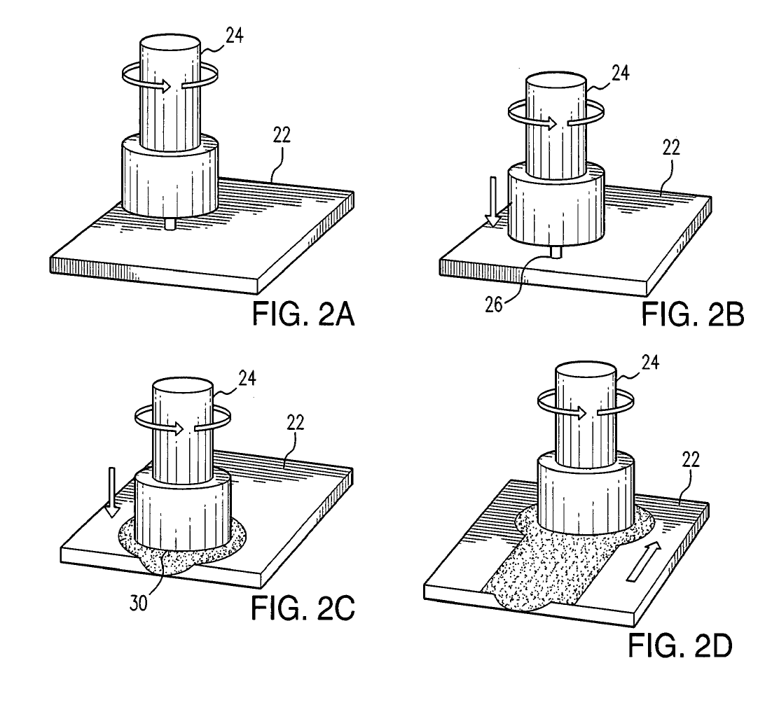

FIGS. 2A-2D schematically illustration typical sequential steps in friction stir processing applied to a work piece. FIG. 2A shows the rotating tool 24 prior to contact with the work piece plate 22. FIG. 2B shows the tool pin 26 of the rotating tool 24 making contact with the work piece plate 22 and creating heat. FIG. 2C shows the tool shoulder 30 of the rotating tool 24 making contact with the work piece plate 22 and restricting further penetration of the tool 24 into the work piece plate 22 while expanding the hot zone. FIG. 2D shows the work piece plate 22 moving relative to the rotating tool 24, creating a fully recrystallized, fine grain microstructure.

In accordance with the invention, materials with a high volume percentage (e.g., >10% and, in some cases, >20%) of nanoparticles can be produced via such a FSP technique. The heavily NP-loaded material can be used as a master alloy such as mixed into a metal matrix in casting, semi-solid processing, or other molten-metal processes, to produce near net shaped nanoparticle reinforced metal matrix components.

Moreover, because FSP is a low temperature process it is possible to incorporate NP's into a metal matrix which would otherwise dissolve or react in the melt. For example, the invention can advantageously be used to introduce NP's, such as graphene, into Al to form a product FSP material. This is in sharp contrast to the application of higher temperature processing, wherein graphene can react with molten Al to form undesirable AlC₄.

Typically, FSP is a high shear rate process which commonly involves plunging a rapidly rotating, non-consumable tool, comprising a profiled pin and larger diameter shoulder, into a metal surface containing pockets of nano-powders and then traversing the tool across the surface. In FSP, frictional heating and extreme deformation occur causing plasticized material and entrained nano-powders (constrained by the shoulder) to flow around the tool and consolidate in the tool's wake. The processed zone subsequently cools, without solidification, as there is no liquid, forming a defect-free recrystallized, fine grain microstructure. Under these conditions the entrained nano-powders do not degrade, separate or agglomerate and are uniformly distributed throughout the FSP zone.

Particular aspects of certain preferred practices of the invention can desirably include one or more of the following:
Preparation of the metal matrix material (MMM) prior to FSP to enable large concentrations of nanoparticles to be encapsulated efficiently and safely into the metal matrix.
Application of FSP conditions to the prepared MMM to form a master alloy wherein nanoparticles are appropriately encapsulated and wetted by the MMM. These conditions can or typically include: the design of the FSP tools (including, FSP tool geometry such as diameter, thread pitch, etc., for example), the feed rate, rotational speed, single or multiple FSP tool passes and other control parameters of the FSP process. For example, suitable friction stir processing conditions can include a friction tool revolution rate in a range of 50 to 5000 RPM and a traverse rate in a range of 0.25 inches/minute to 12 inches/minute. In one specific example, FSP conditions used to incorporate SiC NP's into AZ31 plate material included a 0.25 inch diameter tool rotating at 1000 RPM and traversing the plate at 1 inch/min.
Utilization of the master alloy to enable a desired distribution of nanoparticles into a larger mass of molten metal or semi-solid material with no agglomeration, separation or clustering of the nanoparticles.
Production of NP-loaded MMM and near net shape components with enhanced mechanical and thermal properties.

In accordance with one preferred embodiment, preparation of the MMM prior to FSP desirably includes:
Preparing a slurry of the nanoparticles in a suitable liquid and/or solvent (e.g., water, alcohol or other) with or without appropriate additives. For example, particles mixed with various liquids to make a slurry/paste with up to 60% by weight of solids, can facilitate handling. As identified above, the particles, if desired, can be coated with a material which promotes wetting when distributed in molten metals. Such coating can be realized through the addition or inclusion of appropriate additives to the slurry/paste.
Creating or forming cavities, such as in the form of slots, holes or grooves, for example, in the MMM. Such cavity creation can involve drilling or otherwise appropriately machining the MMM. Alternatively or in addition, if desired, some or all of the cavities can be cast features in the MMM. In addition, the arrangement and size of the cavities can be important. For example, it is generally preferred that there be sufficient metal matrix material available on either side of the cavity to be mixed or spread by the FSP tool into the filled cavity so that intimate mixing of particles and metal matrix occurs. In one specific embodiment, 1.6 mm holes×4 mm deep on a 3 mm pitch have been used.
Filling a plurality of the cavities with the NP slurry either manually or automatically. A variety of methods or techniques are available for filling such cavities with an NP slurry or paste, including: injection, squeezing (pressure) and vacuum assist. In one specific embodiment, NP slurry/paste delivery can be realized through the FSP tool directly into the plate during FSP.
With or without drying the NP slurry. If desired, the paste or slurry filling the cavities can be dried prior to sealing to prevent dried particles from escaping. Alternatively, FSP can be successfully carried out with the paste/slurry still wet and the cavities not sealed such as when the angle of the FSP tool to the metal matrix material is zero (e.g., the shoulder of the tool effectively sealed the cavities ahead of the pin thus preventing escape of the particles).
Closing the cavities filled at least in part with the nanoparticle-containing slurry such as to contain nanoparticles during FSP. For example, such closing or sealing can be realized by traversing filled cavities with a FSP tool without a tip or covering with tape.

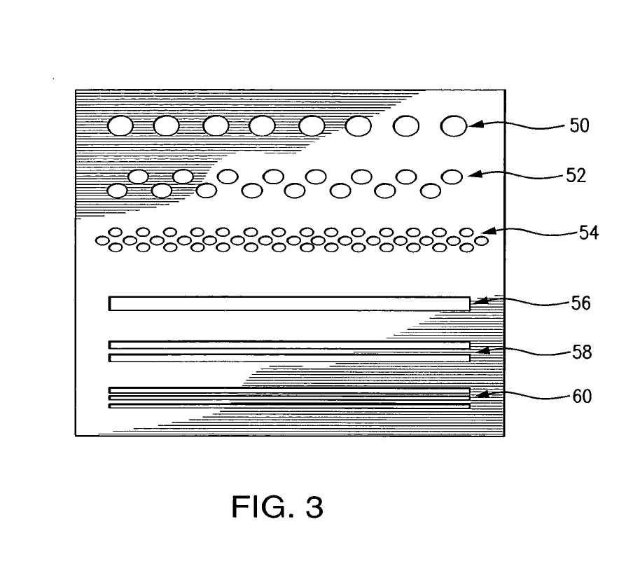

As identified above, cavities in various forms can be created or formed in the MMM for holding or retaining NP's at a desired location or area. Those skilled in the art and guided by the teachings herein provided will appreciate that the general practice of the invention is not limited to any specific or particular arrangement of cavities created or formed in the MMM. Thus, not only the size, shape or form of cavities can be appropriately selected as desired, but also the arrangement of such cavities. By way of example, FIG. 3 schematically illustrates several possible arrangements of cavities for holding NP's in a matrix material. These possible arrangements include:
a series of spaced generally circular holes or cavities 50 in generally linear arrangements;
a series of spaced generally circular holes or cavities 52 in two generally linear rows, such as in an alternating arrangement;
a series of spaced generally circular holes or cavities 54 in three generally linear rows, such as in an alternating arrangement;
a single generally laterally extending slot 56;
a series of two generally parallel laterally extending slots 58; and
a series of three generally parallel laterally extending slots 60.

While the circular holes or cavities 50 are generally larger in diameter than the circular holes or cavities 52 which in turn are larger in diameter than the circular holes or cavities 54, and the slot 56 is generally wider than the slots 58 which in turn are wider than the slots 60, such relative sizes are not necessarily limitations to the broader practice of the invention.

In accordance with one specific embodiment, a method of making the master alloy by FSP involves:
a. drilling cavities in the surface of a suitable MMM plate material;
b. inserting into or appropriately filling the cavities with a slurry containing nanoparticles;
c. drying the slurry;
d. using the shoulder of a FSP tool (pin removed) to seal off the cavities containing the NP-containing slurry; and
e. traversing the area with NP's with a FSP tool in order to incorporate the nanoparticles into the plate material.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### Example 1

### Preparation of a Master Alloy

The preparation of a master alloy in accordance with one embodiment of the invention was done in the following manner:
(a) An array of 2 mm diameter holes was drilled to a depth of 4 mm on 4 mm centers in a 0.5 inch thick 6061 Aluminum plate.
(b) Alumina nanopowders (100 nm) were mixed with alcohol to make a thick paste or slurry. The paste was spread over the drilled area and manually forced into the holes.
(c) The paste was allowed to air dry.
(d) A 0.75 inch diameter FSP tool with the pin removed was used to seal off the holes containing the NP's.
(e) A FSP tool with a 0.25 inch pin and 0.75 inch shoulder was used to traverse the area containing NP's. A traverse rate of 25 mm/minute and a rotational speed of 1000 RPM were used to mix NP's into the aluminum plate.
(f) The area containing NP's was machined into chips to be used as a master alloy for a subsequent casting operation.

In another embodiment, a method of additive friction stir processing is applied. In such method, a slurry or paste containing the NP's is continuously delivered to a position beneath the surface of the substrate/plate via a channel in the rotating FSP tool. Frictional heating occurs at the position where slurry/paste meets the substrate material due to the rotational movement and downward force applied. The mechanical shearing that takes place acts to disperse the NP's in the paste/slurry.

Another aspect of the invention relates to articles made using a master alloy, such as herein described. As detailed further below, the master alloy can desirably be introduced at an appropriate concentration level within the molten material to impart desired properties to the final nanocomposite material.

Relatively small additions of NP's in the castings can provide substantial manufacturing and product quality advantages. Through the invention, nano particles will be dispersed in the metal melt to improve creep properties and associated mechanical properties for the intended application. The dispersing of the nano particles can occur by mixing the added master alloy material into the metallic melt. The nano particles can subsequently be mixed into and dispersed in the metallic melt by convection mixing from the heat of the metallic melt. Alternatively, the nano particles may subsequently be mixed into the metallic melt by an appropriate mixing device, such as a stirrer, electromagnetic mixing, ultrasonic mixing, forced gas mixing, physical mixing devices, and combinations thereof.

Embodiments in which the master alloy material is introduced into the molten material so that the resultant nanoparticle concentration is up to 20 volume percent may be useful for certain applications in which, for example, wear resistance is desirable. In other embodiments, nano-particles are introduced into the molten material via the master alloy such that the resultant nanoparticle concentration is up to about 5 volume percent; such embodiments may be useful for certain applications in which, for example, mechanical properties such as creep rupture strength with suitable ductility are desired. An example would be a cast engine block for an automobile where the nanocomposite material comprises a magnesium alloy and a dispersion of nano sized aluminum oxide (alumina) particles having an average size of about 100 nm or less in at least one dimension, and a concentration of 1% by volume.

A further benefit of the invention is that the castability of matrix alloy is not negatively affected by the addition of NP's up to these levels. This is in contrast to typical processing wherein when additions are made to an alloy to improve performance, the casting quality can be significantly compromised.

### Example 2

Plate Preparation—holes of 1.6 mm in diameter, 4 mm in depth, and 3 mm centers (pitch) were drilled over an 200 mm×200 mm area on a 250 mm×250 mm AZ31 Tooling Plate (wrought plate). The holes were filled with a water based paste containing 50% by weight of 50 nm SiC.

FSP conditions—6.35 mm diameter×4 mm height H13 friction stir tool traversed the plate at 75 mm/min at a speed of 2,000 RPM.

Remelting conditions—Additional AZ31 matrix material was added to the FSP master alloy material and melted together under an argon cover gas. The melt material was mechanically stirred prior to solidifying inside the stainless steel crucible.

Testing—Bolt load retention (BLR) testing has been conducted as an alternative, complementary test for tensile creep test. BLR testing is to characterize the relaxation of the bolt load caused by the stress relaxation of Mg alloys. BLR behaviors of Mg alloys carry more engineering significance than tensile creep behaviors in automotive applications. It is because automotive components are often loaded under compression that the BLR test has been adopted as one of the SAE standard tests.

### Results

Friction Stir Processing—It is estimated that the FSP master alloy material described in Examples 1 and 2 contained approximately 10% by volume of NP's.

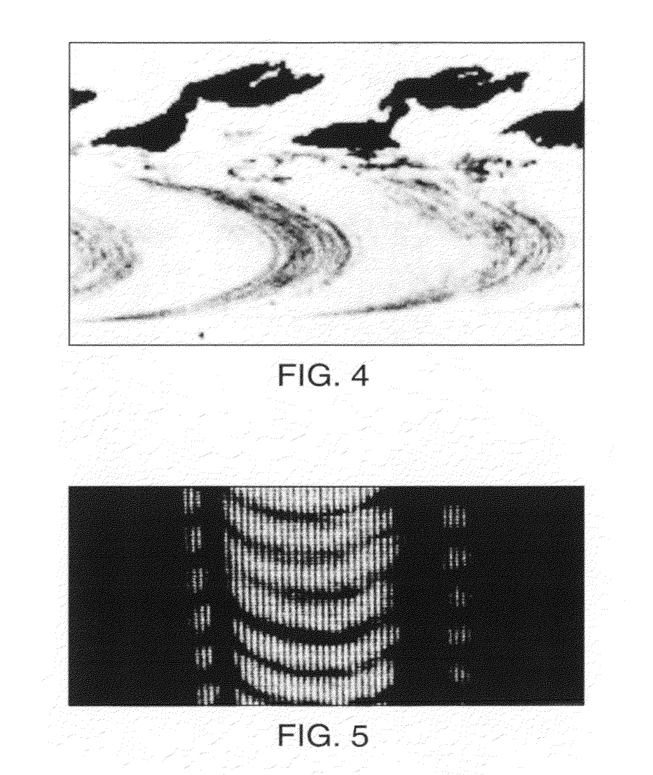

FIG. 4 shows a cross-section through the thickness of a FSP plate (along the line of a series of partially filled holes—NP's occupy the bottom ⅔ of holes while the top ⅓ hole was not filled with NP paste.) in accordance with one embodiment of the invention. Darker bands show distribution and mixing of NP's into metal matrix following a single FSP pass. NP's in the bottom ⅔ of the holes appear to be well mixed into matrix. The swirls are a unique characteristic of the appearance of the microstructures of materials that have been subjected to FSP. The presence of such swirls is a clear indication that FSP was used to process the material shown in FIG. 4.

FIG. 5 shows a plan view of 4 rows of holes filled with tungsten powders—the center 2 rows of holes were FSP'ed—showing the effectiveness of FSP in distributing tungsten powder. Tungsten powders were used for the purpose of X-ray imaging only. The white circles on the opposed sides are holes filled with tungsten powder which have not been FSP. The central region shows the result of FSP'ing the 2 center rows of holes filled with tungsten powder. More specifically, this shows the mixing and distribution of tungsten powders after single FSP pass.

Remelting trials—AZ31 was added to AZ31+SiC master alloy and mixed together to produce ˜2% by volume of NP's in the matrix in argon gas atmosphere.

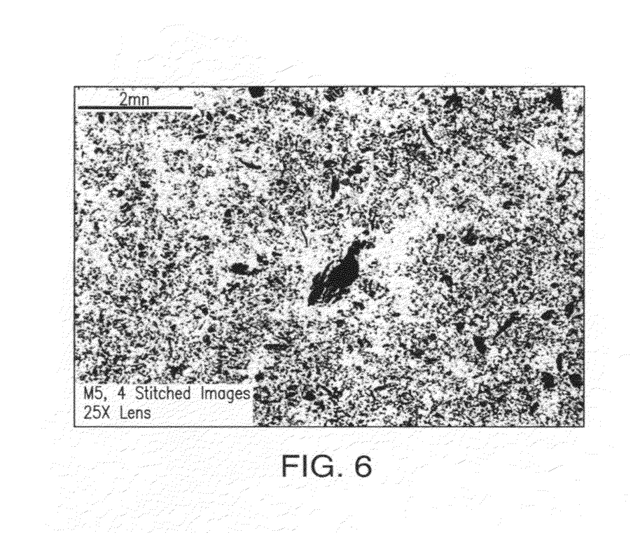

FIG. 6 is a low-magnification optical micrograph of cross-sectioned sample of remelted AZ31+SiC ingot material. Further examination by scanning electron microscope, in the following paragraphs, shows the dark “particles” to be clusters of SiC nanoparticles.

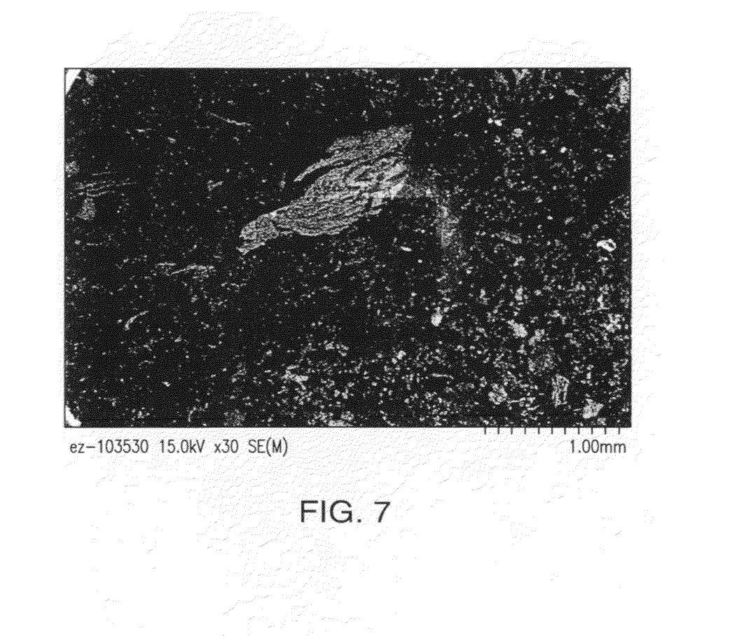

FIG. 7 is a low-magnification scanning electron micrograph (SEM) of the same general area as shown in FIG. 6. However, these two figures have different orientations and mirrored images.

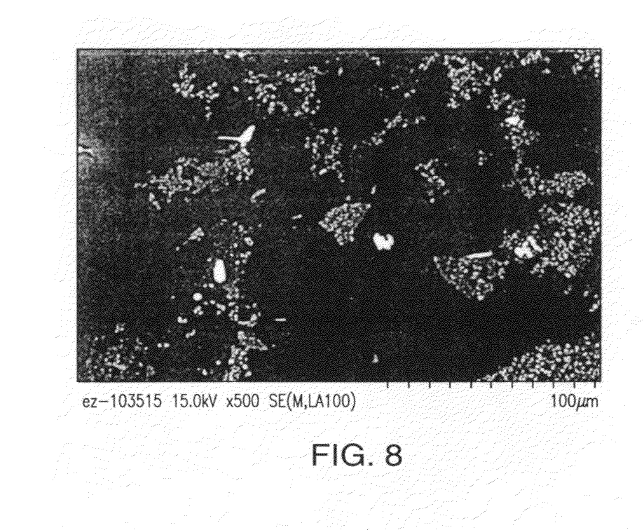

FIG. 8 is a medium-magnification back-scattering (BS) electron micrograph of remelted AZ31+SiC ingot material, in the same general area as in FIG. 6 but with different orientations of images. It shows an area in the center of FIG. 6, showing several clusters of SiC nanoparticles in the Mg matrix (shown as dark “particles” in FIG. 6) and a few white particles. The white particles were identified as Mn—Al compound by EDX technique.

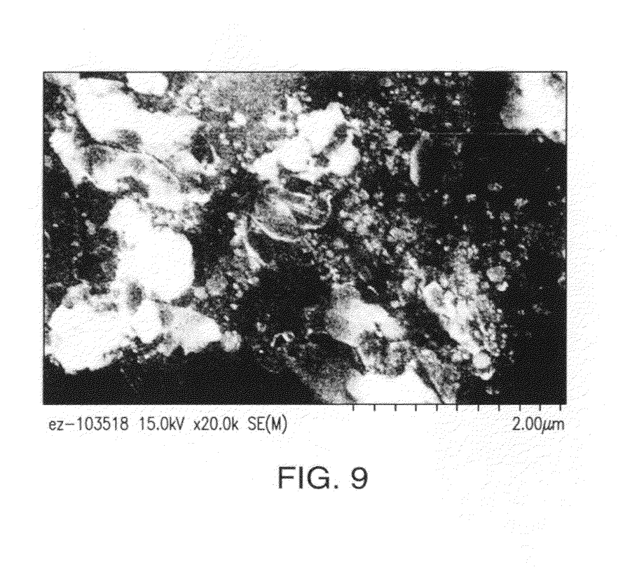

FIG. 9 is a scanning electron micrograph of a SiC nanoparticle cluster of the remelted AZ31+SiC ingot material, showing individual SiC nanoparticles. Higher magnification of the cluster is shown with nano SiC particles in Mg matrix. It is evident that the SiC nanoparticles were dispersed and wet by Mg during the FSP and remelting process.

The size of the cluster is in the same order as Mn—Al compound and Mg—Al—Zn phases which would help in strengthening the Mg matrix.

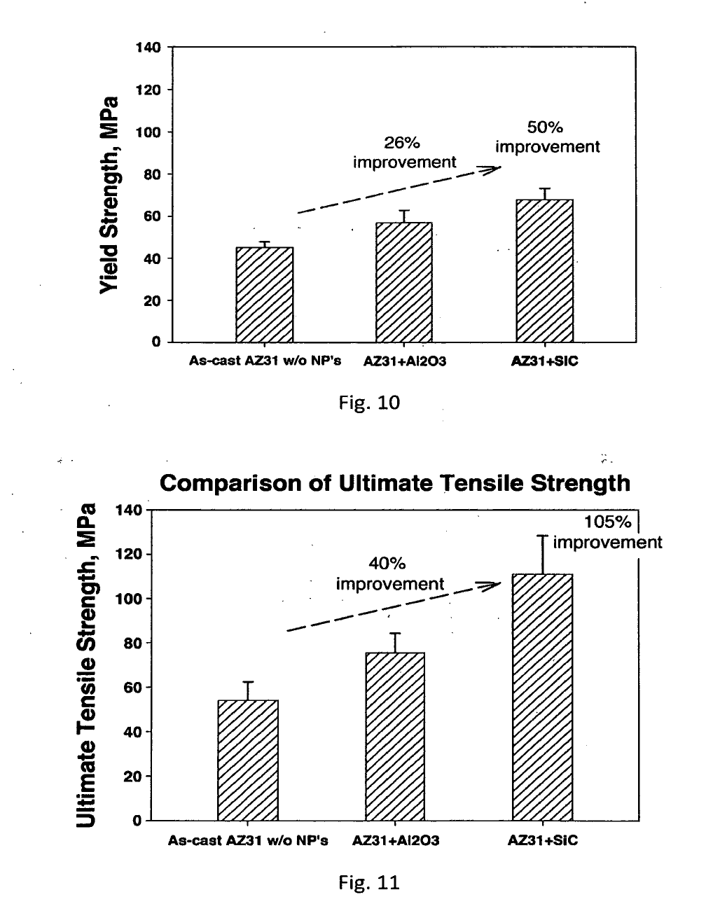

Mechanical properties—The yield strength (YS) and ultimate tensile strength (UTS) of the as-cast ingots produced after remelting and stirring were measured at room temperature and shown in FIGS. 10 and 11, where FIG. 10 is a graph showing comparison of yield strength of as-cast ingots of AZ31, AZ31+Al₂O₃ and AZ31+SiC and FIG. 11 is a graph showing a comparison of ultimate tensile strength of as-cast ingots of AZ31, AZ31+Al₂O₃ and AZ31+SiC.

The UTS of as-cast AZ31+SiC was more than 100% greater than the UTS for as-cast AZ31 without NP's. The YS of AZ31+SiC was 50% greater than that of as-cast AZ31. The AZ31 materials with and without NP's were cast under identical conditions.

### Creep Results

Bolt load Retention (BLR) test—Screws were tightened to 7 N-m prior to immersing in oil bath for 12 hours at 190° C. Then the additional angle required to tighten screw back to 7 N-m was measured. The AZ31+SiC required 47% less turning angle to achieve 7 N-m compared to both as-cast AZ31 and AZ31 wrought plate, showing much less relaxation, or, equivalently, less creep deformation.

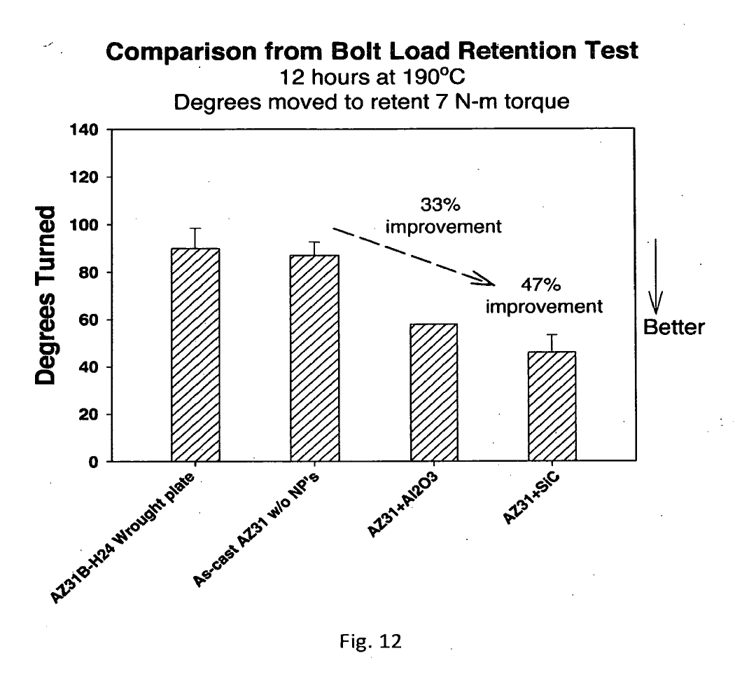

FIG. 12 is a graph showing a comparison from bolt load retention test results for as-cast ZA31, AZ31+SiC and AZ31 wrought plate.

### Conclusions

Remelting has been demonstrated with a master alloy containing a high-percentage (10%) of nanoparticles by friction-stir processing, and achieved about 2 vol. % particles, dispersed and wetted, in Mg matrix.
As-cast Mg (AZ31)+SiC (50 nm) is about 100% stronger than as-cast AZ31.
As-cast Mg (AZ31)+Al₂O₃ (50 nm) is 40% stronger than as-cast AZ31.
Both as-cast Mg (AZ31)+SiC and as-cast Mg (AZ31)+Al₂O₃ require about 40% less additional rotation in the BLR test at 190° C. compared to either as-cast AZ31 or wrought AZ31.

Thus one embodiment of the invention relates to the fabrication of nano composite metal matrix material (MMM) by Friction Stir Processing (FSP) having large concentrations of dispersed nano-size particles typically referred to as a ‘master alloy’.

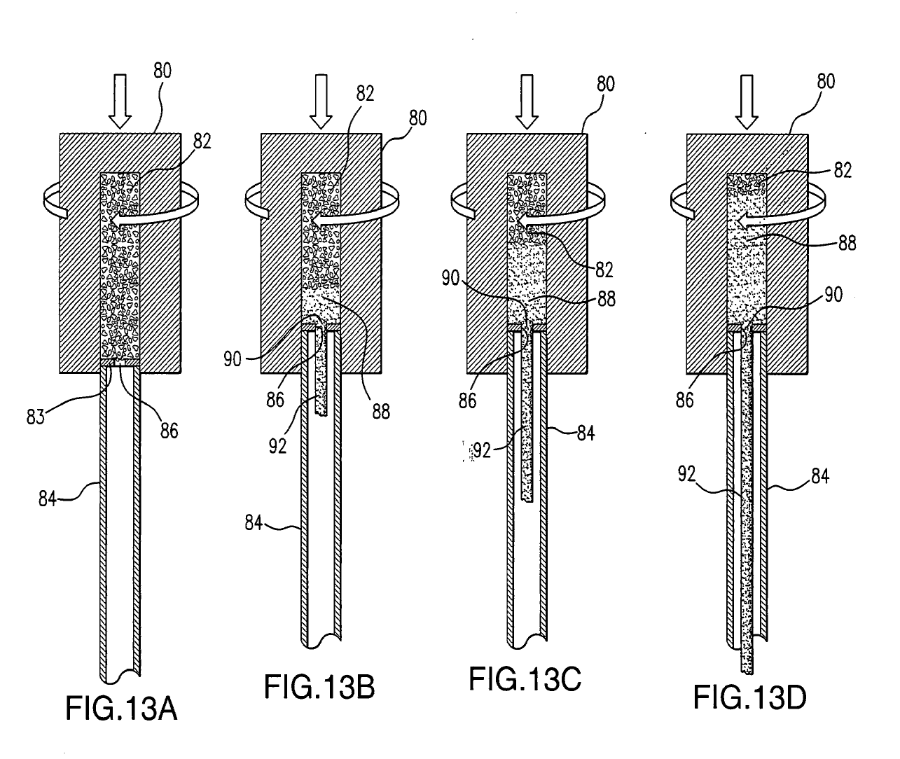

In accordance with another embodiment, a master alloy is desirably made, formed or produced using friction stir extrusion (FSE). FSE utilizes the frictional heating and extensive plastic deformation inherent to the process to stir, consolidate, and synthesis powders, chips, and other feedstock metals directly into useable product forms in a single step. FIGS. 13A-13D show an application of the FSE process in batch mode operation. A rotating cartridge 80 is filled with machining chips/powders of metal matrix material with pre-mixed nano-particle powders to form a feedstock 82. The cartridge 80 is closed with a thin consumable plug 83. An axial load is applied using a plunger/die 84 thereby extruding the material through an orifice 86. The frictional heat and pressure caused by the relative motion and the initial restriction in the axial extrusion flow allow a transition layer 88 and a plasticized layer 90 to form. Considerable heat is generated by the high-strain rate plastic deformation in this layer that softens the material for mixing and consolidation. With continued generation of the plasticized layer and progressive consumption of the feedstock material, the feedstock is hydrostatically consolidated and extruded to form a master alloy extruded rod 92 which in turn can be processed to form master alloy pellets.

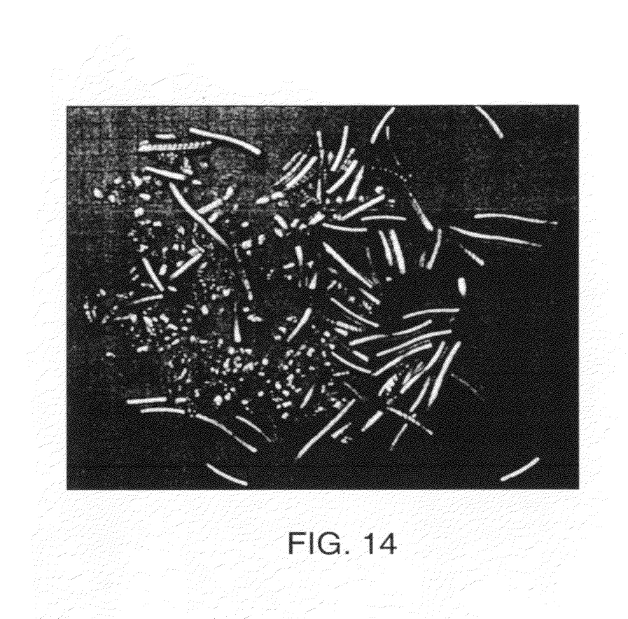

FIG. 14 shows master alloy pellets (i.e., Al₂O₃ nano-particles in an Al 6061 matrix) made by FSE in accordance with one embodiment of the invention.

If desired, master alloys can also be produced by the HIP process with premixed powders/chips of matrix material pre-mixed with nano-particles through high-temperature pressure consolidation.

In view of the above, the invention enables the production of a homogeneous distribution of nanoparticles in a metal matrix material (MMM). NP concentrations up to 20% by volume are evenly distributed into a metal matrix to produce components with enhanced mechanical properties and improved creep resistance.

Thus, the invention generally relates to methods for manufacturing such master alloy materials and their use in casting and semi-solid processes to manufacture NP loaded metal matrix components.

Those skilled in the art and guided by the teachings herein provided will appreciate that the invention may significantly reduce the cost of fabrication of NP-loaded metal matrix components enabling widespread application such as in the automotive and aerospace industries. Further, the invention enables the more widespread application and use of casting as an efficient and cost effective process for manufacturing large complex shaped components.

The invention illustratively disclosed herein suitably may be practiced in the absence of any element, part, step, component, or ingredient which is not specifically disclosed herein. While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method of making a nanoparticle reinforced metal matrix component, the method comprising:
solid state processing nanoparticles into a metal matrix material at solid state processing conditions to form a master alloy, and
adding at least a portion of the master alloy to a mass of metal melt to produce the nanoparticle reinforced metal matrix component.

2. The method of claim 1, wherein the solid state processing is selected from the group consisting of friction stir processing, friction stir extrusion and HIP.

3. The method of claim 1, wherein the nanoparticles of said solid state processing have a size of less than 100 nm.

4. The method of claim 1, wherein the master alloy contains nanoparticles in a volume percentage of greater than 10.

5. The method of claim 1, wherein the master alloy contains up to 30 volume percent nanoparticles.

6. The method of claim 1, wherein the master alloy is added to the metal melt to produce a nanoparticle reinforced metal matrix component with a nanoparticle concentration of up to about 20 volume percent.

7. The method of claim 1, wherein the master alloy is added to the metal melt to produce a nanoparticle reinforced metal matrix component with a nanoparticle concentration of up to about 5 volume percent.

8. The method of claim 1, wherein the master alloy is added to the metal melt to produce a nanoparticle reinforced metal matrix component with a nanoparticle concentration of no more than 2 volume percent.

9. The method of claim 1, wherein the master alloy is added to the metal melt to produce a nanoparticle reinforced metal matrix component with a nanoparticle concentration of at least 0.5 volume percent.

10. The method of claim 1, wherein the metal matrix material comprises at least one material selected from the group consisting of Mg, Al, Sn, Zn, Fe, Ni, Ti and their alloys.

11. The method of claim 1, wherein the metal melt comprises at least one material selected from the group consisting of Mg, Al, Sn, Zn, Fe, Ni, Ti and their alloys.

12. The method of claim 1, wherein the nanoparticles of said solid state processing is a material selected from the group consisting of metal oxides, carbides and metals.

13. The method of claim 1, wherein the nanoparticles of said solid state processing are ceramic.

14. The method of claim 1, wherein said solid state processing comprises friction stir processing at friction stir processing conditions.

15. The method of claim 14, wherein prior to the stir friction processing, the method additionally comprises:
forming a slurry containing the nanoparticles in a suitable liquid, and
filling a plurality of cavities in the metal matrix material at least in part with the nanoparticle-containing slurry.

16. The method of claim 15, wherein prior to said filling, the method additionally comprising:
creating at least some of the cavities in the metal matrix material.

17. The method of claim 16, wherein the creating of cavities in the metal matrix material comprises:
machining the metal matrix material.

18. The method of claim 16, wherein the creating of cavities in the metal matrix material comprises:
casting a plate of the metal matrix material with cavities in place.

19. The method of claim 15, wherein prior to the stir friction processing, the method additionally comprising:
closing at least some of the cavities filled at least in part with the nanoparticle-containing slurry.

20. The method of claim 19, additionally comprising:
drying the slurry filling at least one of the cavities prior to closing that cavity.

21. The method of claim 14, wherein the friction stir processing conditions include a friction tool revolution rate of from 50 to 5000 RPM and a traverse rate from 0.25 inches/minute to 12 inches/minute.

22. The method of claim 14, wherein the friction stir processing conditions include an angle of friction tool to metal matrix material in a range of 0 to 3 degrees from vertical.

23. The method of claim 14, wherein the friction stir processing conditions comprise a single pass of the friction tool relative to the metal matrix material.

24. The method of claim 14, wherein the friction stir processing conditions comprise multiple passes of the friction tool relative to the metal matrix material.

25. The method of claim 1, wherein said solid state processing comprises friction stir extrusion at friction stir extrusion processing conditions.

26. A method of making a nanoparticle reinforced metal matrix component, the method comprising:
forming a slurry containing the nanoparticles in a suitable liquid,
filling a plurality of cavities in a metal matrix material at least in part with the nanoparticle-containing slurry,
friction stir processing nanoparticles in the filled cavities into the metal matrix material at friction stir processing conditions to form a master alloy, and
adding at least a portion of the master alloy to a mass of metal melt to produce the nanoparticle reinforced metal matrix component.
